(19) United States
(12) Patent Application Publication
(10) Pub. No.: US 2015/0079574 A1
(43) Pub. Date: Mar. 19, 2015

(54) ETHNIC AWARENESS EDUCATION GAME SYSTEM AND METHOD

(71) Applicant: D'Anna Cherie Mounia, Sherman Oaks, CA (US)

(72) Inventor: D'Anna Cherie Mounia, Sherman Oaks, CA (US)

(21) Appl. No.: 14/026,740

(22) Filed: Sep. 13, 2013

(51) Int. Cl. G09B 7/08; G09B 7/06; G09B 19/00

(52) U.S. Cl. CPC G09B 7/08; G09B 19/00; G09B 7/066
USPC 434/350; 434/322; 434/362

(57) ABSTRACT

A game system for ethnic awareness education game play includes a video display device, a remote controller for controlling the video display device, and a video display device readable media. The media is operable to cause the video display device to: display a first question; display the correct answer to the first question; display a second question after displaying the correct answer to the first question; and terminate game play when a termination prompt is received from the remote controller.

### CROSS REFERENCE TO RELATED APPLICATIONS

This application is a Continuation of U.S. Non-Provisional application Ser. No. 12/897,090, filed on Oct. 4, 2010. The entire contents and disclosures of the forgoing applications are hereby incorporated by reference.

### BACKGROUND OF INVENTION

This application relates generally to educational games and systems and more particularly ethnic awareness education games and systems.

### SUMMARY

Education is a vital component for continued development of human beings. Even in adults, continued education may be important and satisfying on both a personal and professional level. As will be appreciated by most, the typical educational environment and/or educational techniques may become overbearing and tedious over time.

Learning about one's racial and/or ethnic heritage has become an area of interest for many people. However, like any other topic, the typical ethnic awareness educational environment and/or techniques may make the topic feel boring over time. Therefore, there exists a significant need for an ethnic awareness educational game system and method capable of maintaining interest in the topic.

In particular, this application discloses a game system for ethnic awareness education game play, the system comprising: a video display device; a remote controller for controlling the video display device; a video display device readable media, the media operable to cause the video display device to: display a first question; display the correct answer to the first question; display a second question after displaying the correct answer to the first question; terminate game play when a termination prompt is received from the remote controller.

This application further discloses a computer implemented method for playing an ethnic awareness game comprising: displaying a first question; receiving a display prompt; displaying an answer to the first question in response to receiving the display prompt; and generating a winning code for subsequent use by a participant.

This application also discloses a game system for ethnic awareness education game play, the system comprising: a video display device; a master controller for controlling the video display device; a participant controller for transmitting participant information to the video display device; a video display device readable media, the media operable to cause the video display device to: display a first question; receive participant information from the participant controller; record the participant information; receive a first question answer display prompt from the master controller; display the correct answer to the first question; display a second question after displaying the correct answer to the first question; receive subsequent participant information from the participant controller; record the subsequent participant information; receive a second question answer display prompt from the master controller; display the correct answer to the second question; and terminate game play when a termination prompt is received from the master controller.

### BRIEF DESCRIPTION OF THE DRAWINGS

The drawings, when considered in connection with the following description, are presented for the purpose of facilitating an understanding of the subject matter sought to be protected.

FIG. 1 is an illustration of a ethnic awareness game system;

FIG. 2 is an illustration of an alternative ethnic awareness game system; and

FIG. 3 is an illustrative flow-diagram of an ethnic awareness game method.

### DETAILED DESCRIPTION

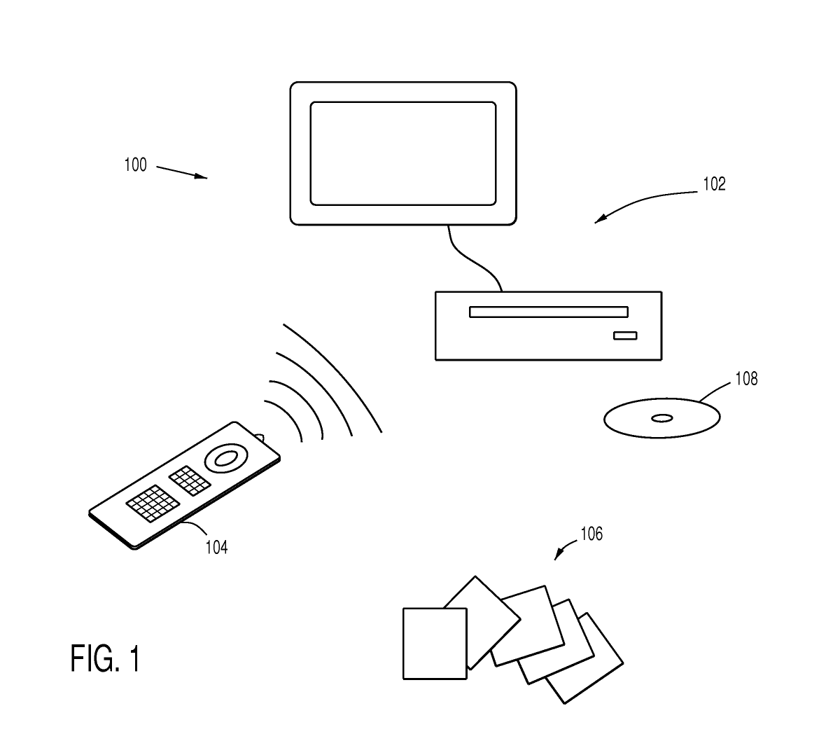

Referring now to FIG. 1, a game system 100 for ethnic awareness game play is shown. The system 100 generally includes a video display device 102, a master controller 104, a plurality of answer cards 106 and a video display device readable media 108. The video display device 102 may be any suitable device, including, but not limited to, a personal computer, a DVD-player and television, etc. As will be discussed below, the video display device 102 may be configured to execute and display game play from the video display device readable media 108 as well as receive commands from the master controller 104.

The master controller 104 may be any device suitable for controlling the video display device 102, including, but not limited to, a wireless remote control, a keyboard, etc. The master controller 104 may communicate with the video display device 102 via any suitable communications means, including, but not limited to, infrared communication, Bluetooth™, wired-communication, etc. The master controller 104 may include control implements, such as one or more buttons, dials, switches, etc., for controlling game play. The master controller 104 may be configured such that depressing, or otherwise activating, one or more control implements causes the controller to communicate one or more game play commands to the display device 102. Suitable commands may include, without limitation, initiate game play, suspend game play, advance game play, terminate game play, etc. In one embodiment, a teacher or other suitable game play facilitator controls the game play with the master controller 104.

The video display device media 108 may be any suitable device for storing instructions executable by the video display device 102. Suitable media 108, include, without limitation, read-only memory, flash memory, one or more magnetic computer storage devices (e.g. hard disks, floppy disks, and magnetic tape), optical discs (e.g. DVDs), etc. As will be further discussed below, in one embodiment, the video display device media 108 may be configured to provide ethnic awareness game play whereby ethnic awareness topics are taught via multiple choice question game play. In one embodiment, one or more questions are also accompanied with one or more multimedia displays (audio, audio-visual, image, video, etc.). Suitable ethnic topics may include, without limitation, culture, pop-culture, history, etc. While the illustrative embodiment employs multiple choice questions in the game play, it will be appreciated that any suitable game and/or teaching technique for providing game play and education may be employed.

The answer cards 106 are configured to display answers to game play questions by one or more students or participants. Each card 106 may be configured to display a letter associated with a possible answer, a color associated with a possible answer, etc. In one embodiment, each participant is provided a plurality of cards 106 with each card being associated with a potential answer to each question. For example, if the game play includes multiple-choice questions with each question having four possible answers, each participant may be provided four cards having different colors, different letters, etc. such that the participant may select one answer for each question. As will be discussed further below, each participant holds up a card associated with a potential answer displayed by the video display device 102.

In operation, game play may be initiated by inserting the media 108 into the display device 102. Game play may then be initiated with the controller 104. After any initial set up, the display device 102 may then display a multiple-choice question for the participants to read along with a list of potential answers. Each participant will pick a card associated with their answer of choice and raise the card up for the facilitator to observe. The facilitator may then depress a button on the controller 104 whereby the display device 102 displays the answer to the question. In an alternative embodiment, the display device 102 may display the answer to the question automatically after a predetermined amount of time. The participants may maintain the cards raised such that the facilitator may then denote which participants provided correct and incorrect answers. In one embodiment, once a participant has provided three incorrect answers (e.g., “three strikes”), the participant may be eliminated from the game. In one embodiment, once all participants but one have been eliminated, the game may be advanced to a subsequent, or “second”, round by depressing an appropriate button on the controller 104. In the second round, the winning participant of the first round may be asked multiple choice questions and provide answers as described above until the participant answers incorrectly. Once the participant answers incorrectly, game play may be terminated via the controller whereby the display device 102 displays a code (such as an alphanumeric code) to be entered into a game tracking website, or otherwise provided to a game tracking provider. The code may be used to identify the winning participant, the participant's score, participant's location, as well as register the participant for other competitions, such as a regional or national competition. While the forgoing illustrative example includes two-rounds, it will be appreciated that any suitable number of rounds may be employed. For example, and without limitation, a three-round game may include a first round of team competition whereby teams of participants compete against one another. After the winning team has been determined, two more rounds may be played as described above (e.g., an intra-team competition whereby the participants of the winning team compete against one another followed then by the winning participant of the intra-team competition answering questions until he or she answers incorrectly).

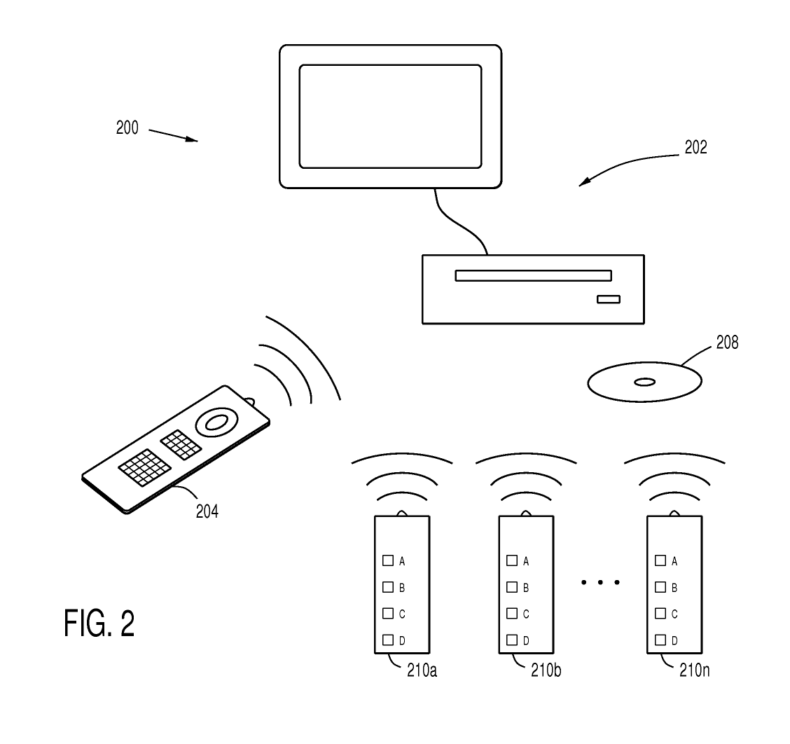

Referring now to FIG. 2, a second game system 200 for ethnic awareness game play is shown. The game system 200 is analogous in most respects to the game system 100 of FIG. 1 and a correlation of parts is generally indicated in this embodiment by indexing the numerals in FIG. 1 by 100. The system 200 generally includes a video display device 202, a master controller 204, a video display device readable media 208, and one or more participant controllers 210. Each of the participant controllers 210 may be configured to communicate an answer of a corresponding participant to any given question to at least one of the display device 202, master controller 204, or secondary controller, expressly programmed to communicate to the participant controllers 210. In one embodiment, the master controller 204 and/or display device 202 records and displays for the facilitator each incorrect answer entered by a participant. In an alternative embodiment, the master controller 204 includes depressable pegs associated with each participant such that the facilitator may record each incorrect answer by each participant. In a further embodiment, the secondary controller may include depressable pegs associated with each participant such that the facilitator may record each incorrect answer by each participant utilizing this secondary controller.

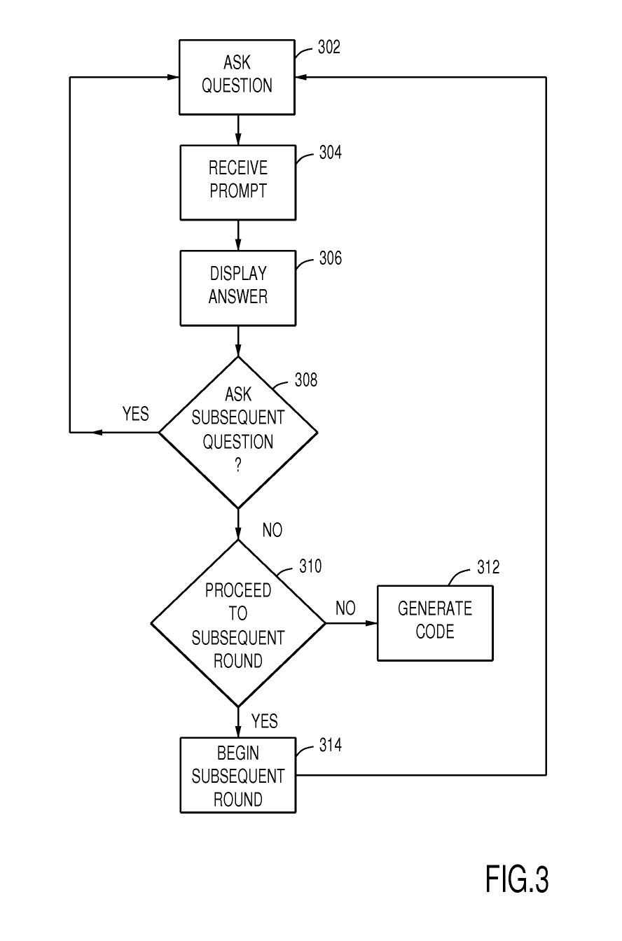

Referring now to FIG. 3, an illustrative flowchart 300 for ethnic awareness game play employing a system the same or similar to those previously shown and described. First, an ethnic awareness question is presented to one or more participants [step 302]. The system then receives a prompt from a facilitator to display the correct answer to the question [step 304]. The correct answer may then be displayed [step 306]. Alternatively, the system may display the correct answer to the question after a predetermined amount of time.

The facilitator and/or system may then record the participants that answered the question incorrectly and eliminate participants after a predetermined number of incorrect answers have been given. The system may then query the facilitator whether a subsequent question should be displayed [step 308]. If the facilitator indicates a subsequent question should be displayed, the system may display a subsequent question [step 302]. However, if the facilitator indicates that a subsequent question should not be asked, the system may query the facilitator whether a subsequent round should be played [step 310].

If the facilitator indicates that a subsequent round should not be played, the system may generate a code to be entered into a game tracking website, or otherwise provided to a game tracking provider [step 312]. The code may be used to identify the winning participant, the participant's score, participant's location, as well as register the participant for other competitions, such as a regional or national competition. Alternatively, game play may merely be terminated. If, however, the facilitator indicates that a subsequent round should be played, a subsequent round may be started [step 314] and question(s) presented [step 302].

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

I claim:

1. A game system for ethnic awareness education game play, the system comprising:
a video display device;
a master controller for controlling the video display device;
a video display device readable media, the media operable to cause the video display device to:
display a first question;
display the correct answer to the first question;
display a second question after displaying the correct answer to the first question;
terminate game play when a termination prompt is received from the master controller.

2. The game system of claim 1 wherein the video display device is a computer.

3. The game system of claim 1 wherein the master controller is a remote control.

4. The game system of claim 1 wherein at least one of the first question and second question is an ethnic awareness question.

5. The game system of claim 1 further comprising a plurality of answer cards for use by one or more participants.

6. The game system of claim 1 wherein at least one of the first and second question comprises a multiple choice question.

7. The game system of claim 1 wherein a winning code is displayed after game play is terminated.

8. The game system of claim 1 further comprising one or more participant controllers for transmitting information from one or more participants to the video display device.

9. A computer implemented method for playing an ethnic awareness game comprising:
displaying a first question;
receiving a display prompt;
displaying an answer to the first question in response to receiving the display prompt;
generating a winning code for subsequent use by a participant, and outputting the winning code from the computer.

10. The method of claim 9 further comprising: displaying a subsequent question;
receiving a subsequent display prompt; and displaying an answer to the subsequent question in response to receiving the subsequent display prompt.

11. The method of claim 10 further comprising receiving a subsequent round prompt and initiating a subsequent round in response thereto.

12. The method of claim 9 further comprising receiving a termination prompt and terminating game play in response thereto.

13. A game system for ethnic awareness education game play, the system comprising:
a video display device;
a master controller for controlling the video display device;
a participant controller for transmitting participant information to the video display device;
a video display device readable media, the media operable to cause the video display device to:
display a first question;
receive participant information from the participant controller;
record the participant information;
receive a first question answer display prompt from the master controller;
display the correct answer to the first question;
display a second question after displaying the correct answer to the first question;
receive subsequent participant information from the participant controller;
record the subsequent participant information;
receive a second question answer display prompt from the master controller;
display the correct answer to the second question; and
terminate game play when a termination prompt is received from the master controller.

14. The game system of claim 13 wherein at least one of the participant information and subsequent participant information comprises a participant answer to one or more question.

15. The game system of claim 13 wherein the video display device is a computer.

16. The game system of claim 13 wherein the master controller is a remote control.

17. The game system of claim 13 wherein at least one of the first question and second question is an ethnic awareness question.

18. The game system of claim 13 wherein the participant controller is a remote control.

19. The game system of claim 13 wherein a winning code is displayed after game play is terminated.

20. The game system of claim 13 wherein at least one of the first and second question comprises a multiple choice question.
